(19) United States
(12) Patent Application Publication
(10) Pub. No.: US 2022/0406239 A1
(43) Pub. Date: Dec. 22, 2022

(54) GAMMA VOLTAGE CORRECTION METHOD, GAMMA VOLTAGE CORRECTION DEVICE, AND DISPLAY DEVICE

(71) Applicant: Shenzhen China Star Optoelectronics Semiconductor Display Technology Co., Ltd., Shenzhen, Guangdong (CN)

(72) Inventors: Wenwu LIAO, Shenzhen, Guangdong (CN); Bin ZHAO, Shenzhen, Guangdong (CN); Mingjong JOU, Shenzhen, Guangdong (CN); Yuhua CHANG, Shenzhen, Guangdong (CN); Dan CAO, Shenzhen, Guangdong (CN); Jianjian YING, Shenzhen, Guangdong (CN)

(73) Assignee: Shenzhen China Star Optoelectronics Semiconductor Display Technology Co., Ltd., Shenzhen, Guangdong (CN)

(21) Appl. No.: 17/260,239

(22) PCT Filed: Dec. 22, 2020
(86) PCT No.: PCT/CN2020/138328

§ 371 Date: Jan. 14, 2021

(30) Foreign Application Priority Data
Dec. 8, 2020 (CN) 202011443219.0

(51) Int. Cl. G09G 3/20

(52) U.S. Cl. CPC G09G 3/2096; G09G 3/2007; G09G 2320/0247; G09G 2320/0276; G09G 2320/0233

(57) ABSTRACT

A gamma voltage correction method, a gamma voltage correction device, and a display device are provided. The gamma voltage correction method is performed on a final confirmed gamma voltage curve of a current frame period in a display stage of a next frame period. Therefore, changes in a gamma voltage curve of the display device may follow changes in frequency, i.e., the frequency and the gamma voltage curve may be consistent. As a result, a brightness difference of the display device caused by changes in frequency may be reduced and flickering may be prevented.

### FIELD

The present disclosure relates to the field of display technologies, and more particularly, to a gamma voltage correction method, a gamma voltage correction device, and a display device.

### BACKGROUND

FREESYNC, a variable refresh rate technology of display devices, dynamically adjusts refresh rates of the display devices by changing duration of a vertical blanking interval (VBI) stage of a data enable signal of image data, thereby matching the refresh rates of the display devices with refresh rates of graphics cards. However, when the refresh rates of the display devices are reduced, the duration of the VBI stage will increase, leading to a severe leakage from the display devices and sudden decreases of brightness. When the refresh rates of the display devices are increased, the duration of the VBI stage will decrease, leading to less leakage from the display devices and sudden increase in brightness, which would dazzle people.

Nowadays, when a frequency changes suddenly, display devices cannot quickly change a gamma correction voltage corresponding to real-time frequency. Therefore, brightness of the display devices may decrease suddenly when the frequency decreases and may increase suddenly when the frequency increases. Specifically, brightness of the display devices will change drastically when the frequency changes, leading to flickering of the display devices.

### SUMMARY

To solve the above problem, the present disclosure provides a gamma voltage correction method, a gamma voltage correction device, and a display device.

In a first aspect, the present disclosure provides a gamma voltage correction method, used in a display device in a variable frequency mode, including following steps:

step S1, prestoring a plurality of frequencies of image data of the display device, and a vertical blanking interval (VBI) and a gamma voltage curve corresponding to each of the frequencies;

step S2, during a current frame period, obtaining current duration of a VBI stage in real time, wherein each current frame period includes a display stage and the VBI stage;

step S3, when the current duration of the VBI stage reaches the VBI, obtaining a frequency corresponding to the current duration of the VBI stage, and obtaining a gamma voltage curve corresponding to the frequency; and

step S4, confirming the gamma voltage curve during the current frame period for the last time, and performing a gamma voltage correction on the image data in a next frame period.

In some embodiments, the step S2 specifically includes:

when the display stage in the current frame period is ended, detecting a current time of the VBI stage in real time in the current frame period; and

confirming an interval between the current time of the VBI stage and an end time of the display stage in the current frame period, and regarding the interval as the current duration of the VBI stage.

In some embodiments, the step S3 specifically includes:

when the current duration of the VBI stage reaches a prestored VBI, obtaining a frequency corresponding to the current duration of the VBI stage according to a frequency corresponding to the prestored VBI; and

obtaining a gamma voltage curve corresponding to the current duration of the VBI stage according to the gamma voltage curve corresponding to the prestored frequency and the frequency corresponding to the current duration of the VBI stage.

In some embodiments, the gamma voltage curve shows a relationship between a pixel grayscale of image data of the display device and a corresponding gamma correction voltage.

In some embodiments, the step S4 specifically includes:

before a display stage in the next frame period, confirming a last VBI which the current duration of the VBI stage in the current frame period reaches;

obtaining a final frequency corresponding to the current duration of the VBI stage in the current frame period according to the frequency corresponding to the prestored VBI and the last VBI which the current duration of the VBI stage in the current frame period reaches;

confirming the gamma voltage curve in the current frame period for the last time according to the gamma voltage curve corresponding to the prestored frequency and the final frequency corresponding to the current duration of the VBI stage in the current frame period;

confirming the gamma correction voltage corresponding to each pixel grayscale included in the gamma voltage curve for the last time according to the gamma voltage curve confirmed in the current frame period for the last time and a plurality of pixel grayscale reference voltages included in the image data; and

performing a gamma correction on each of the pixel grayscale reference voltages corresponding to the gamma correction voltage in the next frame period, thereby obtaining the pixel grayscale voltages corresponding to each of the pixel grayscale reference voltages.

In a second aspect, the present disclosure provides a gamma voltage correction device, used in a variable frequency mode, including:

a prestoring module configured to prestore a plurality of frequencies of image data of the display device, and a vertical blanking interval (VBI) and a gamma voltage curve corresponding to each of the frequencies;

a VBI duration confirming module, used in a current frame period, configured to obtain current duration of a VBI stage in real time, wherein each current frame period includes a display stage and the VBI stage;

a gamma voltage curve generating module configured to obtain a frequency corresponding to the current duration of the VBI stage, and obtaining a gamma voltage curve corresponding to the frequency when the current duration of the VBI stage reaches the VBI; and

a pixel grayscale voltage generating module configured to confirm the gamma voltage curve during the current frame period for the last time, and performing a gamma voltage correction on the image data in a next frame period.

In some embodiments, the VBI duration confirming module includes:

a VBI current time detecting unit configured to detect a current time of the VBI stage in real time in the current frame period when the display stage in the current frame period is ended; and

a VBI duration confirming unit configured to confirm an interval between the current time of the VBI stage and an end time of the display stage in the current frame period, and regarding the interval as the current duration of the VBI stage.

In some embodiments, the gamma voltage curve generating module includes:

a frequency confirming unit configured to obtain a frequency corresponding to the current duration of the VBI stage according to a frequency corresponding to the prestored VBI when the current duration of the VBI stage reaches a prestored VBI; and

a gamma voltage curve generating unit configured to obtain a gamma voltage curve corresponding to the current duration of the VBI stage according to the gamma voltage curve corresponding to the prestored frequency and the frequency corresponding to the current duration of the VBI stage.

In some embodiments, the gamma voltage curve shows a relationship between a pixel grayscale of image data of the display device and a corresponding gamma correction voltage.

In some embodiments, the pixel grayscale voltage generating module includes:

a final VBI duration confirming unit configured to confirm a last VBI which the current duration of the VBI stage in the current frame period reaches before a display stage in the next frame period;

a final frequency confirming unit configured to obtain a final frequency corresponding to the current duration of the VBI stage in the current frame period according to the frequency corresponding to the prestored VBI and the last VBI which the current duration of the VBI stage in the current frame period reaches;

a final gamma voltage curve generating unit configured to confirm the gamma voltage curve in the current frame period for the last time according to the gamma voltage curve corresponding to the prestored frequency and the final frequency corresponding to the current duration of the VBI stage in the current frame period; and

a gamma voltage correction unit configured to perform a gamma correction on each of the pixel grayscale reference voltages corresponding to the gamma correction voltage in the next frame period, thereby obtaining the pixel grayscale voltages corresponding to each of the pixel grayscale reference voltages.

In a third aspect, the present disclosure further provides a display device, including a timing controller, a gamma voltage correction device, a source driving device, a gate driving device, and a display panel, wherein the timing controller is respectively connected to the gate driving device and the gamma voltage correction device, the gamma voltage correction device is connected to the source driving device, and the gate driving device and the source driving device are respectively connected to the display panel.

In some embodiments, the display device works in a stable frequency mode or a variable frequency mode, and the gamma voltage correction device is used in the variable frequency mode.

In some embodiments, the gamma voltage correction device includes:

a prestoring module configured to prestore a plurality of frequencies of image data of the display device, and a vertical blanking interval (VBI) and a gamma voltage curve corresponding to each of the frequencies;

a VBI duration confirming module, used in a current frame period, configured to obtain current duration of a VBI stage in real time, wherein each current frame period includes a display stage and the VBI stage;

a gamma voltage curve generating module configured to obtain a frequency corresponding to the current duration of the VBI stage, and obtaining a gamma voltage curve corresponding to the frequency when the current duration of the VBI stage reaches the VBI; and

a pixel grayscale voltage generating module configured to confirm the gamma voltage curve during the current frame period for the last time, and performing a gamma voltage correction on the image data in a next frame period.

In some embodiments, the VBI duration confirming module includes:

a VBI current time detecting unit configured to detect a current time of the VBI stage in real time in the current frame period when the display stage in the current frame period is ended; and

a VBI duration confirming unit configured to confirm an interval between the current time of the VBI stage and an end time of the display stage in the current frame period, and regarding the interval as the current duration of the VBI stage.

In some embodiments, the gamma voltage curve generating module includes:

a frequency confirming unit configured to obtain a frequency corresponding to the current duration of the VBI stage according to a frequency corresponding to the prestored VBI when the current duration of the VBI stage reaches a prestored VBI; and

a gamma voltage curve generating unit configured to obtain a gamma voltage curve corresponding to the current duration of the VBI stage according to the gamma voltage curve corresponding to the prestored frequency and the frequency corresponding to the current duration of the VBI stage.

In some embodiments, the gamma voltage curve shows a relationship between a pixel grayscale of image data of the display device and a corresponding gamma correction voltage.

In some embodiments, the pixel grayscale voltage generating module includes:

a final VBI duration confirming unit configured to confirm a last VBI which the current duration of the VBI stage in the current frame period reaches before a display stage in the next frame period;

a final frequency confirming unit configured to obtain a final frequency corresponding to the current duration of the VBI stage in the current frame period according to the frequency corresponding to the prestored VBI and the last VBI which the current duration of the VBI stage in the current frame period reaches;

a final gamma voltage curve generating unit configured to confirm the gamma voltage curve in the current frame period for the last time according to the gamma voltage curve corresponding to the prestored frequency and the final frequency corresponding to the current duration of the VBI stage in the current frame period; and

a gamma voltage correction unit configured to perform a gamma correction on each of the pixel grayscale reference voltages corresponding to the gamma correction voltage in the next frame period, thereby obtaining the pixel grayscale voltages corresponding to each of the pixel grayscale reference voltages.

Regarding the beneficial effects: the present disclosure provides a gamma voltage correction method, a gamma voltage correction device, and a display device. The method includes: first, prestoring a plurality of frequencies of image data of the display device, and a vertical blanking interval (VBI) and a gamma voltage curve corresponding to each of the frequencies. Second, during a current frame period, obtaining current duration of a VBI stage in real time, wherein each current frame period includes a display stage and the VBI stage. Third, when the current duration of the VBI stage reaches the VBI, obtaining a frequency corresponding to the current duration of the VBI stage, and obtaining a gamma voltage curve corresponding to the frequency. Finally, confirming the gamma voltage curve during the current frame period for a last time, and performing a gamma voltage correction on the image data in a next frame period. Therefore, the gamma voltage curve of the display device may change following changes in the frequency. That is, the gamma voltage curve and the frequency of the display device may be consistent, thereby solving a problem of drastic changes in brightness of the display device caused by changes in the frequency. As a result, a flickering of the display device may be prevented.

### DESCRIPTION OF DRAWINGS

FIG. 1 is a structural schematic view showing a display device provided by an embodiment of the present disclosure.

FIG. 2 is a schematic flowchart showing a gamma voltage correction method provided by an embodiment of the present disclosure.

FIG. 3 (a) is a first sequence diagram of the gamma voltage correction method provided by an embodiment of the present disclosure.

FIG. 3 (b) is a second sequence diagram of the gamma voltage correction method provided by an embodiment of the present disclosure.

FIG. 4 (a) is a first gamma curve graph of the gamma voltage correction method provided by an embodiment of the present disclosure.

FIG. 4 (b) is a second gamma curve graph of the gamma voltage correction method provided by an embodiment of the present disclosure.

FIG. 5 is a structural schematic view showing a gamma voltage correction device provided by an embodiment of the present disclosure.

### DETAILED DESCRIPTION

Embodiments are further described below in detail with reference to accompanying drawings to make objectives, technical solutions, and effects of the present disclosure clearer and more precise. It should be noted that described embodiments are merely used to construct the present disclosure and are not intended to limit the present disclosure.

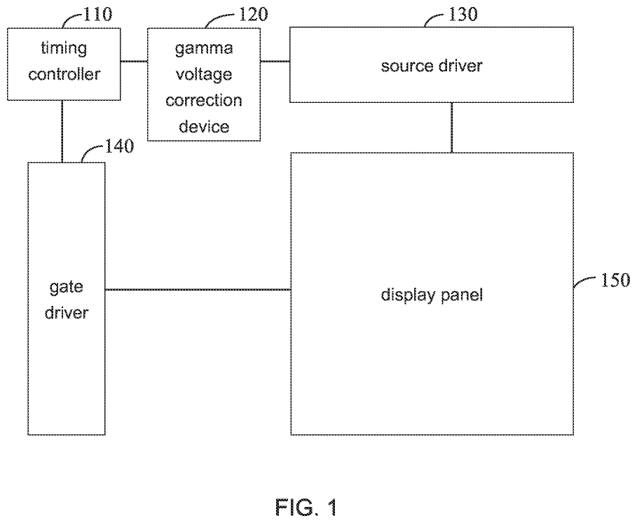

FIG. 1 is a structural schematic view showing a display device provided by an embodiment of the present disclosure. As shown in FIG. 1, the display device includes a timing controller 110, a gamma voltage correction device 120, a source driver 130, a gate driver 140, and a display panel 150. During a process of a gamma voltage correction method, the timing controller 110 receives external image data and obtains a data enable signal according to the external image data. The data enable signal in an image sequentially includes a display stage and a vertical blanking interval (VBI) stage. The gamma voltage correction device 120 is configured to correct gamma voltages of the image data signal according to a gamma voltage curve obtained according to duration of the VBI stage of the data enable signal. After that, the source driver 130 outputs the corrected image data signal to pixels of the display panel 150 in the display stage of the data enable signal. Therefore, the display panel 150 may work normally.

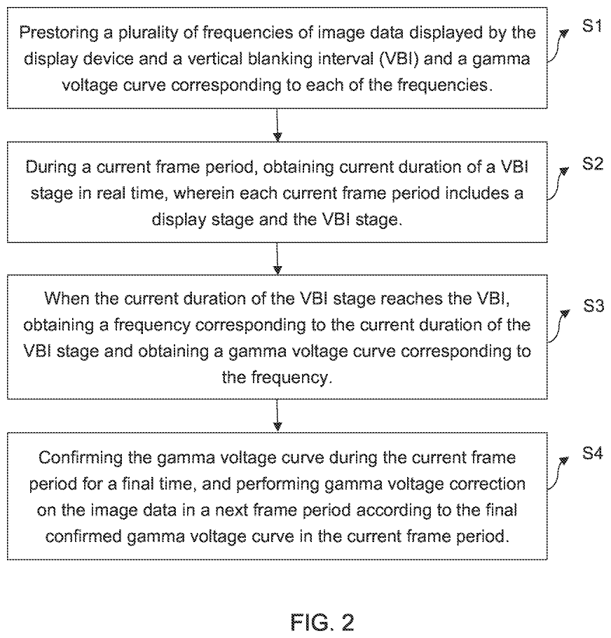

FIG. 2 is a schematic flowchart showing a gamma voltage correction method provided by an embodiment of the present disclosure. As shown in FIG. 2, the present embodiment provides the gamma voltage correction method used in a display device in a variable frequency mode, including following steps:

Step S1, prestoring a plurality of frequencies of image data of the display device and a vertical blanking interval (VBI) and a gamma voltage curve corresponding to each of the frequencies.

Specifically, duration of the VBI stage of the data enable signal and a frequency of the image data are relevant. Furthermore, when the frequency changes, a brightness of the display panel changes as well. Therefore, the gamma voltage curve used during gamma voltage correction of the display panel needs to be changed as well. Specifically, different frequencies correspond to different gamma voltage curves. In the present embodiment, a plurality of frequencies, a plurality of durations of VBI corresponding to the frequencies, and a plurality of gamma voltage curves corresponding to the frequencies are prestored.

It should be noted that a number of the prestored frequencies may be determined according to actual situations. The more prestored frequencies there are, the more VBI and gamma voltage curves need to be prestored, because each of the frequencies corresponds to one VBI and one gamma voltage curve. This means more VBI may be compared with the current duration of the VBI stage, and more frequencies may be chosen to correspond to the gamma voltage curves. Therefore, the gamma voltage correction method may be more accurate.

Step S2, during a current frame period, obtaining current duration of a VBI stage in real time, wherein each current frame period includes a display stage and the VBI stage;

Specifically, each frame period sequentially includes the display stage and the VBI stage which are continuously performed, and the display stage of a next frame starts from an end time of the VBI stage of a previous frame. When the frequency changes, obtaining a current duration of the VBI stage in real time in the current frame period from an end time of the display stage of the current frame.

Step S3, when the current duration of the VBI stage reaches the VBI, obtaining a frequency corresponding to the current duration of the VBI stage and obtaining a gamma voltage curve corresponding to the frequency.

Specifically, based on the plurality of prestored VBIs, when the current duration of the VBI stage reaches the VBI, obtaining a frequency corresponding to the current duration of the VBI stage according to a frequency corresponding to the VBI. Also, obtaining a gamma voltage curve corresponding to the current duration of the VBI stage according to a gamma voltage curve corresponding to the prestored frequencies. The gamma voltage curve corresponding to the current duration is applied to a gamma voltage correction process of the display panel.

Step S4, confirming the gamma voltage curve during the current frame period for a final time, and performing a gamma voltage correction on the image data in a next frame period.

Specifically, before the display stage of the next frame period begins, confirming the gamma voltage curve of the current frame period for a final time and performing gamma voltage correction on image data of the display stage in the next frame period using the gamma voltage curve confirmed for the final time.

This embodiment provides a gamma voltage correction method, wherein a plurality of frequencies of image data of the display device, a vertical blanking interval (VBI) and a gamma voltage curve corresponding to each of the frequencies are prestored. During a current frame period, frequencies of image data are obtained in real time according to the current duration of a VBI stage. Then, required gamma voltage curves are obtained according to the obtained frequencies, and the final confirmed gamma frequencies are used in a next frame period to perform gamma voltage correction according to the final confirmed gamma frequencies in the next frame period. Therefore, the gamma voltage curves of the display device may change following changes in the frequencies. That is, the gamma voltage curves and the frequencies of the display device may be consistent, thereby solving a problem of drastic changes in brightness of the display device caused by changes in the frequencies. As a result, flickering of the display device may be prevented.

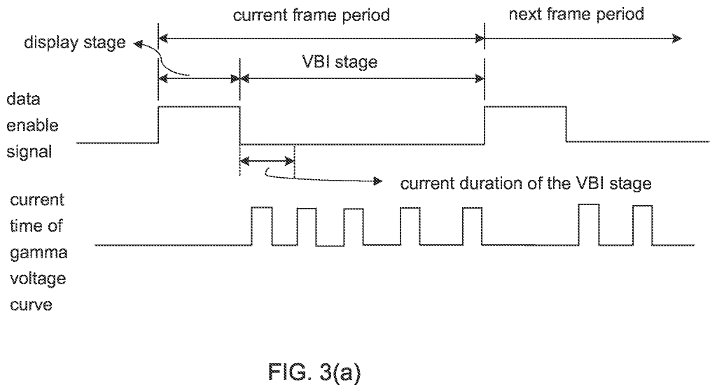

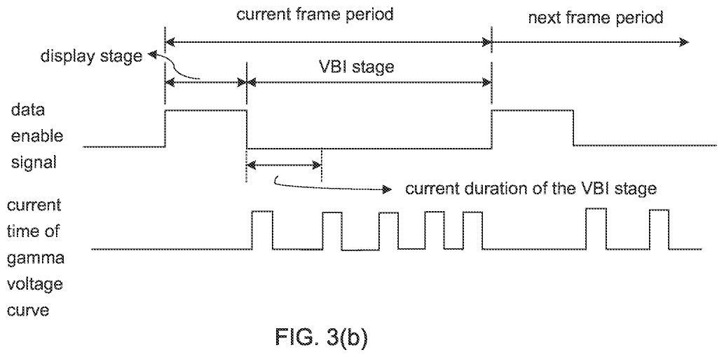

FIG. 3 (a) is a first sequence diagram of the gamma voltage correction method provided by the present embodiment and is a schematic gamma voltage curve when a frequency is reduced. FIG. 3 (b) is a second sequence diagram of the gamma voltage correction method provided by the present embodiment and is a schematic gamma voltage curve when a frequency is increased. A confirmed time of the schematic gamma voltage curves of FIG. 3 (a) and FIG. 3 (b) is a current confirmed time of the VBI stage.

As shown in FIG. 3 (a) or FIG. 3 (b), the step S2 specifically includes:

Step S21, from an end of the display stage of the current frame period, detecting a current time of the VBI stage in real time in the current frame period.

Step S22, confirming an interval between the current time of the VBI stage and an end time of the display stage of the current frame period, and regarding the interval as the current duration of the VBI stage.

As shown in FIG. 3 (a) or FIG. 3 (b), the step S3 specifically includes:

step S31, when the current duration of the VBI stage reaches a prestored VBI (taking the current duration of the VBI stage reaching the prestored VBI second time in FIG. 3 (a) and FIG. 3 (b) as an example), obtaining a frequency corresponding to the current duration of the VBI stage according to a frequency corresponding to the prestored VBI.

Step S32, based on the gamma voltage curve corresponding to the prestored frequency, obtaining a gamma voltage curve corresponding to the current duration of the VBI stage according to the frequency corresponding to the current duration of the VBI stage.

It should be noted that the gamma voltage curve shows a relationship between a pixel grayscale of image data of the display device and a gamma correction voltage corresponding to the pixel grayscale.

As shown in FIG. 3 (a) or FIG. 3 (b), the step S4 specifically includes:

step S41, before the display stage of the next frame period begins, confirming a final VBI which the current duration of the VBI stage in the current frame period reaches.

Step S42, obtaining a final frequency corresponding to the current duration of the VBI stage in the current frame period according to the frequency corresponding to the prestored VBI and the final VBI which the current duration of the VBI stage in the current frame period reaches.

Step S43, obtaining the final confirmed gamma voltage curve in the current frame period according to the gamma voltage curve corresponding to the prestored frequency and the final frequency corresponding to the current duration of the VBI stage in the current frame period.

Step S44, confirming the gamma correction voltage corresponding to each pixel grayscale included in the final confirmed gamma voltage curve according to the final confirmed gamma voltage curve in the current frame period and a plurality of pixel grayscale reference voltages included in the image data.

Step S45, performing a gamma correction on each of the pixel grayscale reference voltages corresponding to the gamma correction voltage in the display stage of the next frame period, thereby obtaining pixel grayscale voltages corresponding to each of the pixel grayscale reference voltages.

Specifically, in the step S4, a final real-time frequency which the current frame period reaches is confirmed according to the frequency corresponding to the VBI which the VBI stage of the current frame period finally reaches. A gamma voltage curve corresponding to the final real-time frequency is used in a final gamma voltage correction process. That is, the gamma voltage correction process is performed on a plurality of pixel grayscale reference voltages included in the image data in the next frame period using the final confirmed gamma voltage curve in the previous frame period, thereby obtaining a plurality of pixel grayscale voltages corresponding to each of the pixel grayscale reference voltages. Taking a 256 grayscale image as an example, image data includes 256 pixel grayscale reference voltages. The gamma voltage correction process is performed on each pixel grayscale reference voltages of the final confirmed gamma voltage curve, thereby obtaining the pixel grayscale voltages corresponding to the pixel grayscale reference voltages. The pixel grayscale voltages drive corresponding grayscales, thereby allowing pixels of the display panel to display images.

It should be noted that FIG. 3 (a) is a schematic view showing an adjustment of gamma voltages when a frequency is reduced. When the frequency is reduced, the VBI will be increased. Therefore, an increase of the VBI follows a decrease of the frequency. Therefore, when the frequency becomes increasingly lower, a time interval between obtaining the gamma voltage curve and obtaining another gamma voltage curve becomes increasingly greater. FIG. 3 (b) is a schematic view showing an adjustment of gamma voltages when the frequency is increased. When the frequency is increased, the VBI will be reduced. Therefore, a decrease of the VBI follows an increase of the frequency. Therefore, when the frequency becomes increasingly higher, a time interval between obtaining the gamma voltage curve and obtaining another gamma voltage curve becomes increasingly shorter.

It should be noted that the gamma voltage correction method may be used in a variable frequency mode.

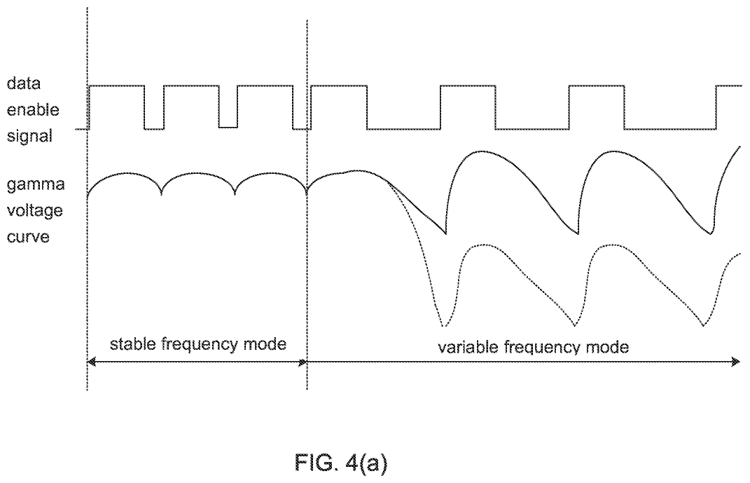

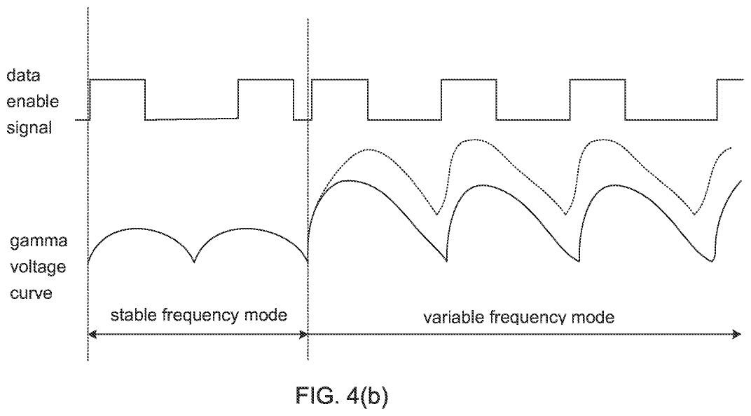

FIG. 4 (a) is a first schematic view showing a gamma curve of the gamma voltage correction method provided by the present embodiment. When the gamma voltage curve in FIG. 4 (a) is changed from a stable frequency mode to a variable frequency mode, it corresponds to the gamma voltage curve in FIG. 3 (a) when the frequency is reduced. Wherein, a dotted line denotes a gamma voltage curve when the frequency is reduced when the gamma voltage correction method is not applied, and a solid line denotes a gamma voltage curve when the frequency is reduced when the gamma voltage correction method is applied. As shown in FIG. 4 (a), when the frequency is reduced, a gamma voltage of the gamma voltage curve may be increased if the gamma voltage correction method is applied, which reduces a brightness difference caused by a shift from a high frequency to a low frequency.

FIG. 4 (b) is a second schematic view showing a gamma curve of the gamma voltage correction method provided by the present embodiment. When the gamma voltage curve in FIG. 4 (b) is changed from a stable frequency mode to a variable frequency mode, it corresponds to the gamma voltage curve in FIG. 3 (b) when the frequency is increased. Wherein, a dotted line denotes a gamma voltage curve when the frequency is increased when the gamma voltage correction method is not applied, and a solid line denotes a gamma voltage curve when the frequency is increased when the gamma voltage correction method is applied. As shown in FIG. 4 (b), when the frequency is increased, a gamma voltage of the gamma voltage curve may be decreased if the gamma voltage correction method is applied, which reduces a brightness difference caused by a transformation from a high frequency to a low frequency.

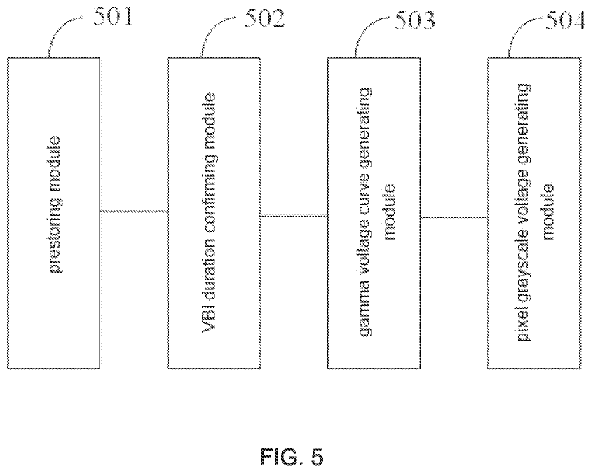

FIG. 5 is a structural schematic view showing a gamma voltage correction device provided by the present embodiment. As shown in FIG. 5, the present embodiment provides the gamma voltage correction device, used in the variable frequency mode of the display device, including:

a prestoring module 501 configured to prestore a plurality of frequencies of image data of the display device, and a vertical blanking interval (VBI) and a gamma voltage curve corresponding to each of the frequencies;

a VBI duration confirming module 502, used in a current frame period, configured to obtain current duration of a VBI stage in real time, wherein each current frame period includes a display stage and the VBI stage;

a gamma voltage curve generating module 503 configured to obtain a frequency corresponding to the current duration of the VBI stage, and obtaining a gamma voltage curve corresponding to the frequency when the current duration of the VBI stage reaches the VBI; and

a pixel grayscale voltage generating module 504 configured to perform a gamma voltage correction on the image data in a next frame period according to the final confirmed gamma voltage curve in the current frame period.

This embodiment provides a gamma voltage correction method, wherein a plurality of frequencies of image data of the display device, a vertical blanking interval (VBI) and a gamma voltage curve corresponding to each of the frequencies are prestored. During a current frame period, frequencies of image data are obtained in real time according to the current duration of a VBI stage. Then, required gamma voltage curves are obtained according to the obtained frequencies, and the final confirmed gamma frequencies are used in a next frame period to perform gamma voltage correction according to the final confirmed gamma frequencies in the next frame period. Therefore, the gamma voltage curves of the display device may change following changes in the frequencies. That is, the gamma voltage curves and the frequencies of the display device may be consistent, thereby solving a problem of drastic changes in brightness of the display device caused by changes in the frequencies. As a result, flickering of the display device may be prevented.

In some embodiment, the VBI duration confirming module 502 includes:

a VBI current duration detecting unit configured to detect a current time of the VBI stage of the current frame period in real time when the display stage in the current frame period ends; and

a VBI duration confirming unit configured to confirm an interval between the current time of the VBI stage and an end time of the display stage in the current frame period, and regarding the interval as the current duration of the VBI stage.

In some embodiments, the gamma voltage curve generating module 503 includes:

a frequency confirming unit configured to obtain a frequency corresponding to the current duration of the VBI stage according to a frequency corresponding to the prestored VBI when the current duration of the VBI stage reaches a prestored VBI; and

a gamma voltage curve generating unit configured to obtain a gamma voltage curve corresponding to the current duration of the VBI stage according to the gamma voltage curve corresponding to the prestored frequency and the frequency corresponding to the current duration of the VBI stage.

In some embodiments, the gamma voltage curve shows a relationship between a pixel grayscale of image data of the display device and a corresponding gamma correction voltage.

In some embodiments, the pixel grayscale voltage generating module 504 includes:

a final VBI duration confirming unit configured to confirm a final VBI which the current duration of the VBI stage in the current frame period reaches before a display stage of the next frame period begins;

a final frequency confirming unit configured to obtain a final frequency corresponding to the current duration of the VBI stage in the current frame period according to the frequency corresponding to the prestored VBI and the final VBI which the current duration of the VBI stage in the current frame period reaches;

a final gamma voltage curve generating unit configured to obtain the final confirmed gamma voltage curve in the current frame period f according to the gamma voltage curve corresponding to the prestored frequency and the final frequency corresponding to the current duration of the VBI stage of the current frame period; and

a gamma voltage correction unit configured to perform gamma voltage correction on each of the pixel grayscale reference voltages corresponding to the gamma correction voltage in the next frame period, thereby obtaining the pixel grayscale voltages corresponding to each of the pixel grayscale reference voltages.

In summary, many changes and modifications to the described embodiment can be carried out by those skilled in the art, and all such changes and modifications are intended to be included within the scope of the appended claims.

1. A gamma voltage correction method, used in a display device in a variable frequency mode, comprising following steps:
step S1, prestoring a plurality of frequencies of image data displayed by the display device and a vertical blanking interval (VBI) and a gamma voltage curve corresponding to each of the frequencies;
step S2, during a current frame period, obtaining current duration of a VBI stage in real time, wherein each current frame period includes a display stage and the VBI stage;
step S3, when the current duration of the VBI stage reaches the VBI, obtaining a frequency corresponding to the current duration of the VBI stage and obtaining a gamma voltage curve corresponding to the frequency; and
step S4, confirming the gamma voltage curve during the current frame period for a final time, and performing gamma voltage correction on the image data in a next frame period according to the final confirmed gamma voltage curve in the current frame period.

2. The method of claim 1, wherein the step S2 includes following steps:
detecting a current time of the VBI stage in real time in the current frame period from an end of the display stage of the current frame period; and
confirming an interval between the current time of the VBI stage and an end time of the display stage in the current frame period, and regarding the interval as the current duration of the VBI stage.

3. The method of claim 1, wherein the step S3 includes following steps:
when the current duration of the VBI stage reaches the prestored VBI, obtaining the frequency corresponding to the current duration of the VBI stage according to the frequency corresponding to the prestored VBI; and
obtaining a gamma voltage curve corresponding to the current duration of the VBI stage according to the gamma voltage curve corresponding to the prestored frequency and the frequency corresponding to the current duration of the VBI stage.

4. The method of claim 1, wherein the gamma voltage curve shows a relationship between a pixel grayscale of the image data displayed by the display device and a gamma correction voltage corresponding to the pixel grayscale.

5. The method of claim 4, wherein the step S4 comprises following steps:
before a display stage in the next frame period begins, confirming a final VBI which the current duration of the VBI stage in the current frame period reaches;
obtaining a final frequency corresponding to the current duration of the VBI stage in the current frame period according to the frequency corresponding to the prestored VBI and the final VBI which the current duration of the VBI stage in the current frame period reaches;
obtaining the final confirmed gamma voltage curve in the current frame period according to a gamma voltage curve corresponding to the prestored frequency and the final frequency corresponding to the current duration of the VBI stage in the current frame period;
confirming the gamma correction voltage corresponding to each pixel grayscale included in the final confirmed gamma correction voltage curve according to the final confirmed gamma voltage curve in the current frame period and a plurality of pixel grayscale reference voltages included in the image data; and
performing gamma correction on each of the pixel grayscale reference voltages corresponding to a gamma correction voltage in the next frame period, thereby obtaining pixel grayscale voltages corresponding to each of the pixel grayscale reference voltages.

6. A gamma voltage correction device, used in a variable frequency mode of a display device, the gamma voltage correction device comprising:
a prestoring module configured to prestore a plurality of frequencies of image data displayed by the display device and a vertical blanking interval (VBI) and a gamma voltage curve corresponding to each of the frequencies;
a VBI duration confirming module, used in a current frame period and configured to obtain current duration of a VBI stage in real time, wherein each current frame period includes a display stage and the VBI stage;
a gamma voltage curve generating module configured to obtain a frequency corresponding to the current duration of the VBI stage and obtain a gamma voltage curve corresponding to the frequency when the current duration of the VBI stage reaches the VBI; and
a pixel grayscale voltage generating module configured to confirm a final gamma voltage curve during the current frame period, and perform gamma voltage correction on the image data in a next frame period.

7. The gamma voltage correction device of claim 6, wherein the VBI duration confirming module comprises:
a VBI current time detecting unit configured to detect a current time of the VBI stage in real time in the current frame period when the display stage in the current frame period ends; and
a VBI duration confirming unit configured to confirm an interval between the current time of the VBI stage and an end time of the display stage in the current frame period, and regard the interval as the current duration of the VBI stage.

8. The gamma voltage correction device of claim 6, wherein the gamma voltage curve generating module comprises:
a frequency confirming unit configured to obtain a frequency corresponding to the current duration of the VBI stage according to a frequency corresponding to the prestored VBI when the current duration of the VBI stage reaches the prestored VBI; and
a gamma voltage curve generating unit configured to obtain a gamma voltage curve corresponding to the current duration of the VBI stage according to the gamma voltage curve corresponding to the prestored frequency and the frequency corresponding to the current duration of the VBI stage.

9. The gamma voltage correction device of claim 6, wherein the gamma voltage curve shows a relationship between a pixel grayscale of image data displayed by the display device and a gamma correction voltage corresponding to the pixel grayscale.

10. The gamma voltage correction device of claim 9, wherein the pixel grayscale voltage generating module comprises:
a final VBI duration confirming unit configured to confirm a final VBI which the current duration of the VBI stage in the current frame period reaches before a display stage in the next frame period begins;
a final frequency confirming unit configured to obtain a final frequency corresponding to the current duration of the VBI stage in the current frame period according to the frequency corresponding to the prestored VBI and the final VBI which the current duration of the VBI stage in the current frame period reaches;
a final gamma voltage curve generating unit configured to obtain a the final confirmed gamma voltage curve in the current frame period according to the gamma voltage curve corresponding to the prestored frequency and the final frequency corresponding to the current duration of the VBI stage in the current frame period; and
a gamma voltage correction unit configured to perform gamma correction on each of pixel grayscale reference voltages corresponding to a gamma correction voltage in the next frame period, thereby obtaining pixel grayscale voltages corresponding to each of the pixel grayscale reference voltages.

11. A display device, comprising a timing controller, a gamma voltage correction device, a source driving device, a gate driving device, and a display panel, wherein the timing controller is respectively connected to the gate driving device and the gamma voltage correction device, the gamma voltage correction device is connected to the source driving device, and the gate driving device and the source driving device are respectively connected to the display panel.

12. The display device of claim 11, wherein the display device works in a stable frequency mode or a variable frequency mode, and the gamma voltage correction device is used in the variable frequency mode.

13. The display device of claim 11, wherein the gamma voltage correction device comprises:
a prestoring module configured to prestore a plurality of frequencies of image data displayed by the display device and a vertical blanking interval (VBI) and a gamma voltage curve corresponding to each of the frequencies;
a VBI duration confirming module, used in a current frame period and configured to obtain current duration of a VBI stage in real time, wherein each current frame period includes a display stage and the VBI stage;
a gamma voltage curve generating module configured to obtain a frequency corresponding to the current duration of the VBI stage and obtain a gamma voltage curve corresponding to the frequency when the current duration of the VBI stage reaches the VBI; and
a pixel grayscale voltage generating module configured to confirm a final gamma voltage curve during the current frame period, and perform gamma voltage correction on the image data in a next frame period.

14. The display device of claim 13, wherein the VBI duration confirming module comprises:
a VBI current time detecting unit configured to detect a current time of the VBI stage in real time in the current frame period when the display stage in the current frame period ends; and
a VBI duration confirming unit configured to confirm an interval between the current time of the VBI stage and an end time of the display stage in the current frame period and regard the interval as the current duration of the VBI stage.

15. The display device of claim 13, wherein the gamma voltage curve generating module comprises:
a frequency confirming unit configured to obtain a frequency corresponding to the current duration of the VBI stage according to a frequency corresponding to the prestored VBI when the current duration of the VBI stage reaches the prestored VBI; and
a gamma voltage curve generating unit configured to obtain a gamma voltage curve corresponding to the current duration of the VBI stage according to the gamma voltage curve corresponding to the prestored frequency and the frequency corresponding to the current duration of the VBI stage.

16. The display device of claim 13, wherein the gamma voltage curve shows a relationship between a pixel grayscale of image data displayed by the display device and a corresponding gamma correction voltage corresponding to the pixel grayscale.

17. The display device of claim 16, wherein the pixel grayscale voltage generating module comprises:
a final VBI duration confirming unit configured to confirm a final VBI which the current duration of the VBI stage in the current frame period reaches before a display stage in the next frame period begins;
a final frequency confirming unit configured to obtain a final frequency corresponding to the current duration of the VBI stage in the current frame period according to the frequency corresponding to the prestored VBI and the final VBI which the current duration of the VBI stage in the current frame period reaches;
a final gamma voltage curve generating unit configured to obtain a final confirmed gamma voltage curve in the current frame period according to the gamma voltage curve corresponding to the prestored frequency and the final frequency corresponding to the current duration of the VBI stage in the current frame period; and
a gamma voltage correction unit configured to perform gamma correction on each of pixel grayscale reference voltages corresponding to a gamma correction voltage in the next frame period, thereby obtaining pixel grayscale voltages corresponding to each of the pixel grayscale reference voltages.
